(19) United States
(12) Patent Application Publication
(10) Pub. No.: US 2013/0031320 A1
(43) Pub. Date: Jan. 31, 2013

(54) CONTROL DEVICE, CONTROL METHOD AND STORAGE APPARATUS

(71) Applicant: Zhongzhong MIN, Kawasaki (JP)

(72) Inventor: Zhongzhong MIN, Kawasaki (JP)

(73) Assignee: FUJITSU LIMITED, Kawasaki-shi (JP)

(21) Appl. No.: 13/488,720

(22) Filed: Jun. 5, 2012

(30) Foreign Application Priority Data
Jul. 27, 2011 (JP) 2011-164021

(51) Int. Cl. G06F 12/16

(52) U.S. Cl. 711/162; 711/E12.103

(57) ABSTRACT

A control device includes a receiver that receives an instruction to update first data stored in a first volume to second data, and a copy processor that starts copying the first data into a second volume in response to the reception of the update instruction by the receiver and limits the start of copying of the first data from the second volume into a third volume until data that is stored in the first volume is completely copied into the second volume.

### CROSS-REFERENCE TO RELATED APPLICATION

This application is based upon and claims the benefit of priority of the prior Japanese Patent Application No. 2011-164021, filed on Jul. 27, 2011, the entire contents of which are incorporated herein by reference.

### FIELD

The embodiments discussed herein are related to a control device, a control method and a storage apparatus.

### BACKGROUND

For a storage apparatus, One Point Copy (OPC) that is a function of copying all data stored in a volume at a certain time into a copy volume is known. The OPC enables data to be logically copied from a business volume into a copy volume at all times. The OPC enables the copy volume to be backed up in a tape device while an operation is continuously performed using the business volume before completion of an operation of physically copying the data.

In addition, a technique for switching a storage medium at each of times (a generation of data to be acquired varies depending on the time of the acquisition) of acquisition of data (of different generations) to be backed up and backing up the data of the different generations is known.

Japanese Laid-open Patent Publications Nos. 2005-284609 and 2009-223508 are examples of the related art.

The OPC causes the entire original data to be copied. Specifically, in order to copy data (to be updated) and generate backup data, all data that includes the data to be updated is copied. Thus, there is a problem that when OPC is activated to copy data of a later generation before OPC is completely executed to copy data between volumes in order to increase the number of generations of data to be backed up, a part of the data may not be copied into another volume.

### SUMMARY

According to an aspect of the invention, a control device includes a receiver that receives an instruction to update first data stored in a first volume to second data, and a copy processor that starts copying the first data into a second volume in response to the reception of the update instruction by the receiver and limits the start of copying of the first data from the second volume into a third volume until data that is stored in the first volume is completely copied into the second volume.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage apparatus according to a first embodiment.

FIG. 2 is a block diagram illustrating a storage system according to a second embodiment.

FIG. 3 is a block diagram illustrating functions of a control module according to the second embodiment.

FIGS. 4A and 4B are diagrams illustrating an OPC process that is performed by an OPC processor.

FIG. 5 is a diagram illustrating generation management information.

FIG. 6 is a diagram illustrating OPC management information.

FIG. 7 is a flowchart of a process that is performed by a write request processor.

FIG. 8 is a flowchart of an OPC activation process.

FIG. 9 is a flowchart of an OPC process.

FIG. 10 is a flowchart of the OPC process.

FIGS. 11A to 11D are diagrams illustrating a first specific example.

FIG. 12 is a diagram illustrating the first specific example.

FIGS. 13A to 13C are diagrams illustrating a second specific example.

FIGS. 14A to 14C are diagrams illustrating a third specific example.

FIG. 15 is a diagram illustrating the third specific example.

### DESCRIPTION OF EMBODIMENTS

Hereinafter, embodiments of a storage apparatus disclosed herein are described in detail with reference to the accompanying drawings. First, a first embodiment of the storage apparatus disclosed herein is described. After that, a second embodiment of the storage apparatus disclosed herein is described in more detail.

### First Embodiment

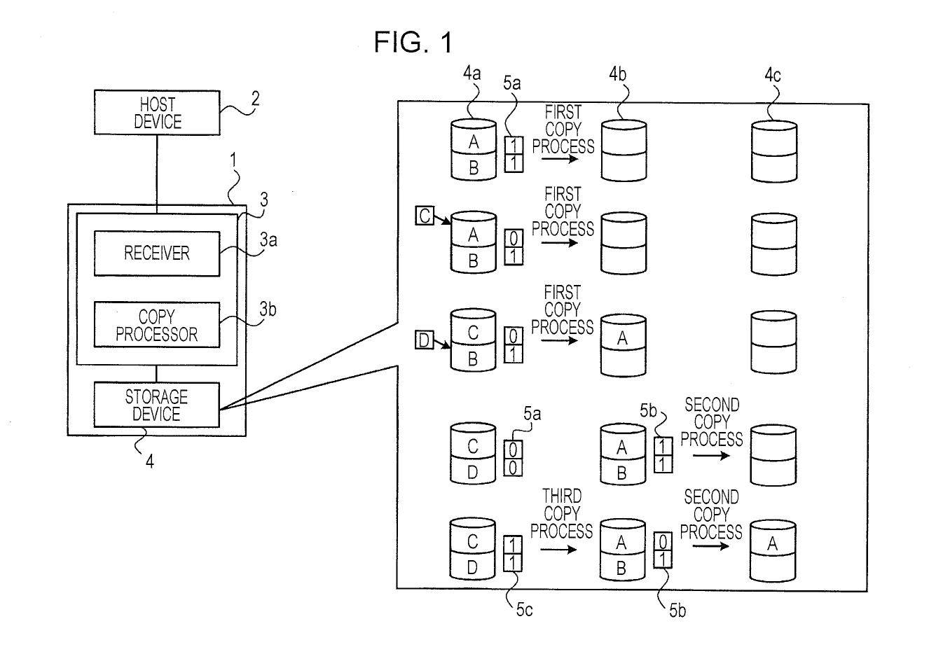

FIG. 1 is a diagram illustrating a storage apparatus 1 according to the first embodiment.

The storage apparatus 1 according to the first embodiment is connected to a host device 2 through a telecommunication line, an optical communication line or the like.

The storage apparatus 1 has a control device (computer) 3 and a storage device 4. The storage device 4 has a storage region capable of storing information. The storage apparatus 4 has one or more hard disk drives (HDDs), one or more solid state drives (SSDs), or the like.

The inside of a detailed figure illustrated in FIG. 1 indicates a transition of a process that is performed by the control device 3. Volumes 4a, 4b and 4c illustrated in FIG. 1 are logical volumes that are formed in a part of the storage region of the storage device 4. The volume 4a is an example of a first volume. The volume 4b is an example of a second volume. The volume 4c is an example of a third volume.

The control device 3 remains asynchronous with each of the volumes 4a, 4b and 4c. When the control device 3 receives, from the host device 2, an instruction to copy data from the volume 4a into the volume 4b, the control device 3 copies the data stored in the volume 4a into the volume 4b, for example. Data A and B of a first generation is stored in the volume 4a illustrated in FIG. 1.

The control device 3 includes a receiver 3a and a copy processor 3b. The receiver 3a and the copy processor 3b can be achieved by a function of a central processing unit (CPU) (not illustrated) that is included in the control device 3.

The receiver 3a receives, from the host device 2, an instruction to update the data A stored in the volume 4a to data C of a second generation that is subsequent to the first generation.

The copy processor 3b starts a process (hereinafter referred to as “first copy process”) of copying the data A and B into the volume 4b in response to the reception of the update instruction by the receiver 3a. Specifically, the copy processor 3b prepares a bit map 5a that indicates the progress of the process of copying the data A and B from the volume 4a into the volume 4b. A value (“0” indicating completion or “1” indicating incompletion) that indicates whether or not the copying (physical copying) of the data A into the volume 4b has been completed is set in an upper bit (illustrated in FIG. 1) of the bit map 5a. A value that indicates whether or not the copying of the data B into the volume 4b has been completed is set in a lower bit (illustrated in FIG. 1) of the bit map 5a. In FIG. 1, the bit map 5a is illustrated near the volume 4a in order to clarify the description of the process that is performed by the control device 3.

When the receiver 3a receives, from the host device 2, the instruction to update the data A stored in the volume 4a to the data C after the copy processor 3b starts the first copy process, the copy processor 3b confirms the progress (indicated by the bit map 5a) of the copying of the data A. When the copy processor 3b confirms that the data A that is stored in the volume 4a is completely copied into the volume 4b, the copy processor 3b permits the data C to be written in a storage region in which the data A is stored in the volume 4a. The copy processor 3b limits the start of copying of the data A from the volume 4b into the volume 4c until the data A that is stored in the volume 4a is completely copied into the volume 4b. By limiting the start of the copying of the data A, it is possible to suppress the fact that only the data A is copied into the volume 4c while the data A is not completely copied into the volume 4b. By suppressing the copying of only the data, it is possible to suppress the occurrence of a deviation (caused by the copying of the data) between generations of data.

After that, when the receiver 3a receives, from the host device 2, an instruction to update the data B stored in the volume 4a to the data D, the copy processor 3b confirms the progress (indicated by the bit map 5a) of copying of the data B. When the copy processor 3b confirms that the data B that is stored in the volume 4a is completely copied into the volume 4b, the copy processor 3b permits the data D to be written in a storage region in which the data B is stored in the volume 4a.

When the copy processor 3b references the bit map 5a and confirms that all the data A and B is completely copied from the volume 4a into the volume 4b, the copy processor 3b permits the start of a process (hereinafter referred to as “second copy process”) of copying data from the volume 4b into the volume 4c that is a copy destination of the data stored in the volume 4b. In addition, the copy processor 3b prepares a bit map 5b that indicates the progress of the process of copying the data A and B from the volume 4b into the volume 4c.

After that, the copy processor 3b starts a process (hereinafter referred to as “third copy process”) of copying the data C and D stored in the volume 4a into the volume 4b in accordance with an instruction transmitted by the host device 2. The copy processor 3b prepares a bit map 5c that indicates the progress of the process of copying the data C and D stored in the volume 4a into the volume 4b.

The storage apparatus 1 can suppress the fact that only the data A is copied into the volume 4c while the copying is not completed. Thus, the storage apparatus 1 can suppress the occurrence of a deviation (caused by the copying of the data) between generations of data.

### Second Embodiment

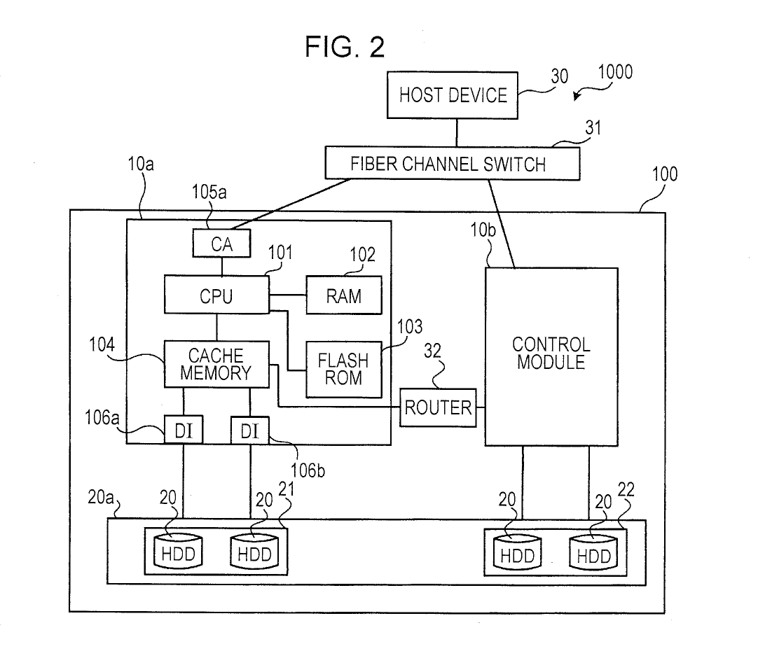

FIG. 2 is a block diagram illustrating a storage system 1000 according to a second embodiment.

The storage system 1000 includes a host device 30 and a storage apparatus 100 that is connected to the host device 30 through a fiber channel (FC) switch 31. Referring to FIG. 2, the host device 30 is connected to the storage apparatus 100. A plurality of host devices, however, may be connected to the storage apparatus 100.

The storage apparatus 100 includes a drive enclosure (DE) 20a and control modules (CMs) 10a and 10b. The drive enclosure 20a includes a plurality of HDDs 20. The control modules 10a and 10b manage physical storage regions of the drive enclosure 20a using Redundant Array of Inexpensive/Independent Disks (RAID). In the present embodiment, the HDDs 20 are exemplified as storage media included in the drive enclosure 20. The storage media are not limited to the HDDs 20. SSDs or other storage media may be used as the storage media included in the drive enclosure 20. When the plurality of HDDs that are included in the drive enclosure 20 are not distinguished from one another, the plurality of HDDs 20 are called a “HDD 20 group”. The total capacity of the HDD 20 group is in a range of 600 GB (giga bytes) to 240 TB (tera bytes), for example.

The storage apparatus 100 uses the control modules 10a and 10b for an operation and thereby ensures redundancy. The number of control modules included in the storage apparatus 100 is not limited to 2. Three or more control modules may be included in the storage apparatus 100 and enable the storage apparatus 100 to ensure redundancy. The storage apparatus 100 may use only the control module 10a.

The control modules 10a and 10b are each an example of a control device. The control modules 10a and 10b are achieved by the same hardware configuration.

The control modules 10a and 10b each use RAID and control access to data stored in the physical storage regions of the HDDs 20 included in the drive enclosure 20a in accordance with a request (transmitted by the host device 30) to access the data.

Since the control modules 10a and 10b are achieved by the same hardware configuration, the hardware configuration of the control module 10a is described as a representative of the control modules 10a and 10b.

The control module 10a has a CPU 101, a random access memory (RAM) 102, a flash read only memory (flash ROM) 103, a cache memory 104, a channel adapter (CA) 105a, and device interfaces (DIs) 106a and 106b.

The CPU 101 executes a program stored in the flash ROM 103 or the like and thereby comprehensively controls the entire control module 10a. The RAM 102 temporarily stores at least a part of the program to be executed by the CPU 101 and various data to be used for a process to be performed under the program. The flash ROM 103 is a nonvolatile memory and stores the program to be executed by the CPU 101 and various data to be used to execute the program.

The flash ROM 103 stores data stored in the cache memory 104 upon a power failure of the storage apparatus 100 or the like.

The cache memory 104 temporarily stores data written in the HDD 20 group and data read from the HDD 20 group.

When the control module 10a receives, from the host device 30, a command to read data, the control module 10a determines whether or not the cache memory 104 has stored therein the data to be read. When the cache memory 104 has stored therein the data to be read, the control module 10a transmits the data (to be read) stored in the cache memory 104 to the host device 30. Thus, the control module 10a can transmit the data to the host device 30 more quickly than reading of the data from the HDD 20 group.

The cache memory 104 may temporarily store data to be used for a process to be executed by the CPU 101. An example of the cache memory 104 is a volatile semiconductor device such as a static random access memory (SRAM). The capacity of the cache memory 104 is not limited, but is in a range of 2 GB to 64 GB, for example.

The channel adapter 105a is connected to the fiber channel switch 31 and connected to the host device 30 through the fiber channel switch 31. The channel adapter 105a has an interface function of enabling data to be transmitted and received between the host device 30 and the control module 10a.

The device interfaces 106a and 106b are connected to the drive enclosure 20a. The device interfaces 106a and 106b each have an interface function of enabling data to be transmitted and received between the HDD 20 group and the cache memory 104. The control module 10a transmits and receives data to and from the HDD 20 group through the device interfaces 106a and 106b.

The control modules 10a and 10b are connected to each other through a router 32. When the host device 30 transmits, to the control module 10a through the channel adapter 105a, data that indicates a request to write data in the HDD 20 group, the CPU 101 causes the received data to be stored in the cache memory 104. In addition, the CPU 101 transmits the received data to the control module 10b through the router 32. The control module 10b causes the data received by a CPU included in the control module 10b to be stored in a cache memory included in the control module 10b. This process causes the same data to be stored in both cache memory 104 included in the control module 10a and cache memory included in the control module 10b.

The drive enclosure 20a has a RAID group that includes one or more HDDs 20 that are among the HDDs 20 included in the drive enclosure 20a. The RAID group is called a “logical volume”, “a virtual disk”, a “RAID logical unit (RLU)” or the like in some cases.

FIG. 2 illustrates two RAID groups 21 and 22 that form RAID 5. The configurations of the RAID groups 21 and 22 are an example and not limited to the configurations illustrated in FIG. 2. For example, the RAID groups 21 and 22 each have an arbitrary number of HDDs 20. The RAID groups 21 and 22 may be configured by an arbitrary RAID level such as RAID 6.

Next, functions of the control module 10a are described.

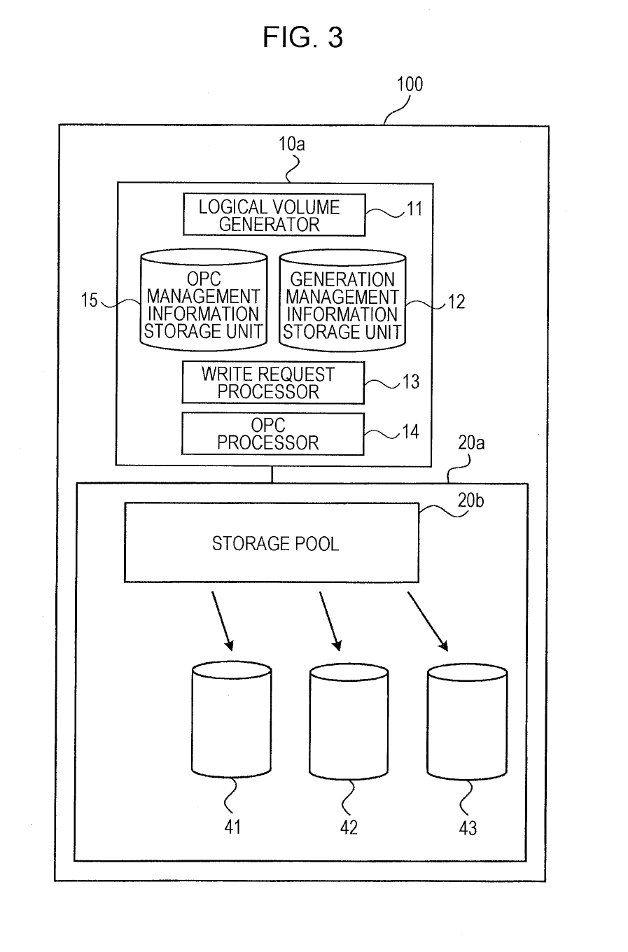

FIG. 3 is a block diagram illustrating the functions of the control module 10a according to the second embodiment.

The control module 10a includes a logical volume generator 11, a generation management information storage unit 12, a write request processor 13, an OPC processor 14 and an OPC management information storage unit 15. The write request generator 13 is an example of a receiver. The OPC processor 14 is an example of a copy processor.

The storage apparatus 100 has a storage pool (virtual storage region) 20b made up of a part or all of the HDDs 20 included in the drive enclosure 20a.

The logical volume generator 11 generates, in accordance with an instruction (issued by the OPC processor 14) to generate a logical volume, a logical volume to which a part of the storage region of the storage pool 20b is assigned. The logical volume generator 11 can generate a logical volume to which a capacity of the storage pool 20b is assigned without a limitation of a physical boundary between the HDDs 20. In FIG. 3, logical volumes 41, 42 and 43 are generated.

Information (generation management information) that is used to manage generations of data stored in the RAID groups 21 and 22 is stored in the generation management information storage unit 12. The generation management information is described later.

When the write request processor 13 confirms a request (issued by the host device 30) to write data, the write request processor 13 specifies, on the basis of information (for example, a logical block address or the like) that is included in the write request and specifies a region in which the data is to be written, a logical volume in which the data is to be written and a region in which the data to be written. Then, the write request processor 13 determines whether or not an OPC session (to be used to execute OPC) that includes the logical volume in which the data is to be written has been established. When the logical volume in which the data is to be written has been established, the write request processor 13 stands by until a bit that is included in a bit map and specifies a region (target copy region) from which the data is to be copied by OPC is set from “1” (indicating incompletion of the copying) to “0” (indicating completion of the copying). When the bit that is included in the bit map and specifies the region from which the data is to be copied is set to “0”, the write request processor 13 writes the data (indicated in the write request issued by the host device 30) in the specified region included in the specified logical volume.

The OPC processor 14 establishes an OPC session between logical volumes in accordance with a request (issued by the host device 30) to activate OPC and executes OPC. When the data is completely copied from the target copy region, the OPC processor 14 sets, to “0”, the bit that is included in the bitmap and specifies the target copy region.

When an OPC session is established between logical volumes in which data of a plurality of generations is stored, the OPC processor 14 confirms, before starting OPC to copy data of a certain generation, completion of copying of data of the previous generation and starts OPC to copy the data of the certain generation. This process suppresses the start of OPC to be executed so that a logical volume into which only a part of data to be copied is copied is treated as a copy source.

Information that is related to logical volumes between which an OPC session is established is stored in the OPC management information storage unit 15.

The functions of the control module 10a are described above. The control module 10b has the same functions as the control module 10a.

Next, an OPC process is described.

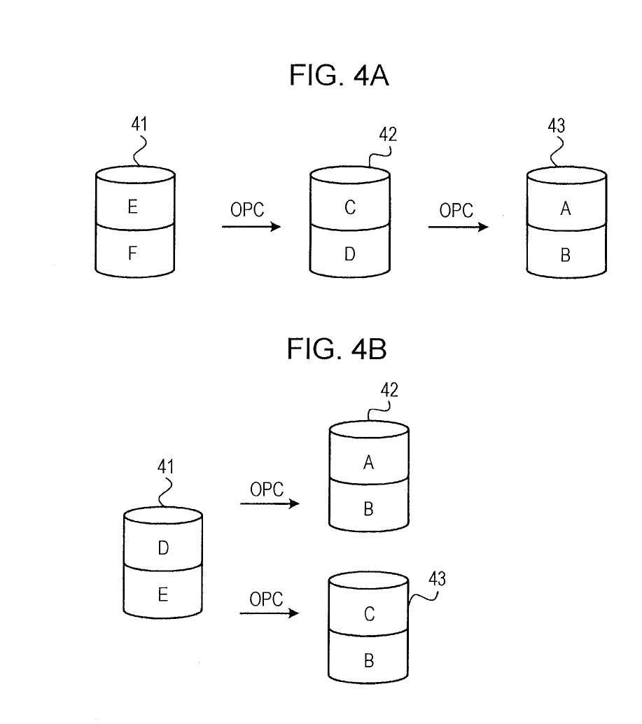

FIGS. 4A and 4B are diagrams illustrating the OPC process that is performed by the OPC processor 14.

Referring to FIG. 4A, the data A and B of the first generation is stored in the logical volume 43, the data C and D of the second generation is stored in the logical volume 42, and data E and F of a third generation is stored in the logical volume 41.

The data A and B of the first generation has been previously stored in the logical volume 41. The OPC processor 14, however, executes OPC in accordance with a request (transmitted from the host device 30) to write the data C and D and thereby copies the data A and B into the logical volume 42. Then, the OPC processor 14 executes OPC in accordance with a request (transmitted from the host device 30) to write the data E and F and thereby copies the data A and B into the logical volume 43.

The write request processor 13 performs a process of writing the data C and D of the second generation in accordance with the request (transmitted from the host device 30) to write the data C and D, and thereby writes the data C and D in the logical volume 41. After that, the OPC processor 14 executes OPC in accordance with the request (transmitted from the host device 30) to write the data E and F and thereby copies the data C and D into the logical volume 42.

The write request processor 13 performs a process of writing the data E and F of the third generation in accordance with the request (transmitted from the host device 30) to write the data E and F, and thereby writes the data E and F in the logical volume 41.

In the present embodiment, the data C and D is called data of a width generation for the data A and B, while the data A and B is called data of a width generation for the data C and D. Specifically, the data C and D is called data of a next width generation for the data A and B, while the data A and B is called data of a previous width generation for the data C and D.

Referring to FIG. 4B, the data A and B of the first generation is stored in the logical volume 42. The data B of the first generation and the data C of the second generation are stored in the logical volume 43. The data D of the second generation and the data E of the third generation are stored in the logical volume 41.

The data A and B (of the first generation) that are stored in the logical volume 42 has been previously stored in the logical volume 41. The OPC processor 14 executes OPC in accordance with a request (transmitted from the host device 30) to write the data D and E and thereby copies the data A and B into the logical volume 42.

The OPC processor 14 executes OPC in accordance with a request transmitted from the host device 30 during the execution of OPC to copy the data A and B of the first generation into the logical volume 42 and thereby copies the data C (of the second generation) written in the logical volume 41 and the data B (of the first generation) stored in the logical volume 41 into the logical volume 43.

The request processor 13 performs a process of writing the data D and E in accordance with a request (transmitted from the host device 30) to write the data D and E and thereby writes the data D and E in the logical volume 41.

In the present embodiment, the data C and B is called data of a height generation for the data A and B, while the data A and B is called data of a height generation for the data C and B. Specifically, the data C and B is called data of a next height generation for the data A and B, while the data A and B is called data of a previous height generation for the data C and B.

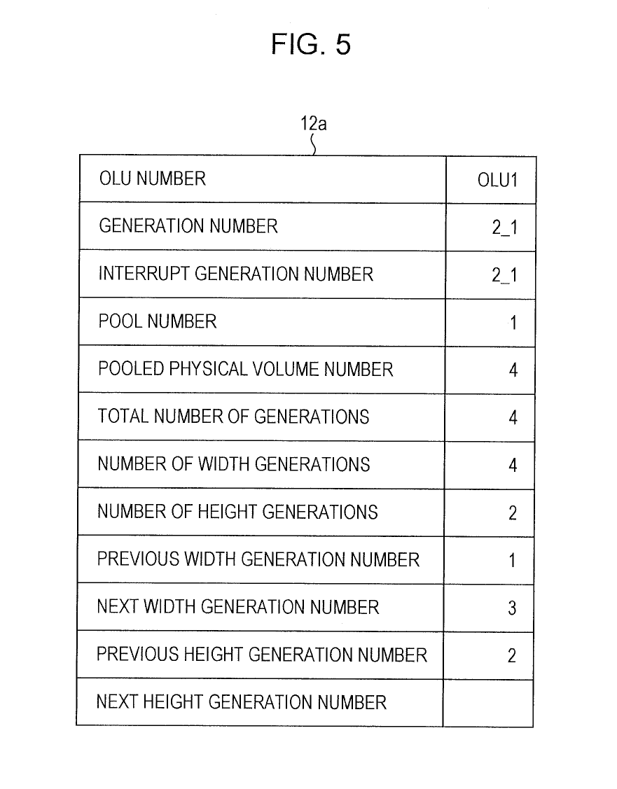

FIG. 5 is a diagram illustrating the generation management information.

Information that is used to manage generations of data is stored in the generation management information storage unit 12.

An OLU number (OLU_NUMBER), a generation number (GENERATION_NUMBER), an interrupt generation number (INTERRUPT_GENERATION_NUMBER), a pool number (POOL_NUMBER), a pooled physical volume number (POOL_SSLU_NUMBER), the total number of generations (TOTAL_GENERATIONS), the total number of width generations (TOTAL_WIDTH_GENERATION), the total number of height generations (TOTAL_HEIGHT_GENERATION), a previous width generation number (PREV_WIDTH_GENERATION_OLU_NUMBER), a next width generation number (NEXT_WIDTH_GENERATION_OLU_NUMBER), a previous height generation number (PREV_HEIGHT_GENERATION_OLU_NUMBER) and a next height generation number (NEXT_HEIGHT_GENERATION_OLU_NUMBER) are set in a generation management table 12a illustrated in FIG. 5.

A number that can be identified by the host device 30 and identifies a logical volume in which data of an interested generation is stored is set in a field for the OLU number.

A number that identifies the interested generation is set in a field for the generation number. The generation number is set by the write request processor 13 when the write request processor 13 receives the data from the host device 30.

When the data of the interested generation is generated by an interrupt process (described later), a number that indicates that the interested generation is a height generation is set in a field for the interrupt generation number. For example, referring to FIG. 4B, the data C and B that is stored in the logical volume 43 is data of an interrupt generation for the data A and B stored in the logical volume 42.

A number that identifies the storage pool 20b is set in a field for the pool number.

A number that identifies a RAID group that exists in the storage pool 20b is set in a field for the pooled physical volume number.

The number of data items that are older than the data of the interested generation is set in a field for the total number of generations.

The number of width generations that include the interested generation is set in a field for the total number of width generations.

The number of height generations that include the interested generation is set in a field for the total number of height generations.

A generation number that identifies a width generation previous to the interested generation is set in a field for the previous width generation number. When the width generation that is previous to the interested generation does not exist, the field for the previous width generation number is blank.

A generation number that indicates a width generation subsequent to the interested generation is set in a field for the next width generation number. When the width generation that is subsequent to the interested generation does not exist, the field for the next width generation number is blank.

A generation number that indicates a height generation previous to the interested generation is set in a field for the previous height generation number. When the height generation that is previous to the interested generation does not exist, the field for the previous height generation number is blank.

A generation number that indicates a height generation subsequent to the interested generation is set in a field for the next height generation number. When the height generation that is subsequent to the interested generation does not exist, the field for the next height generation number is blank.

Next, OPC management information that is stored in the OPC management information storage unit 15 is described.

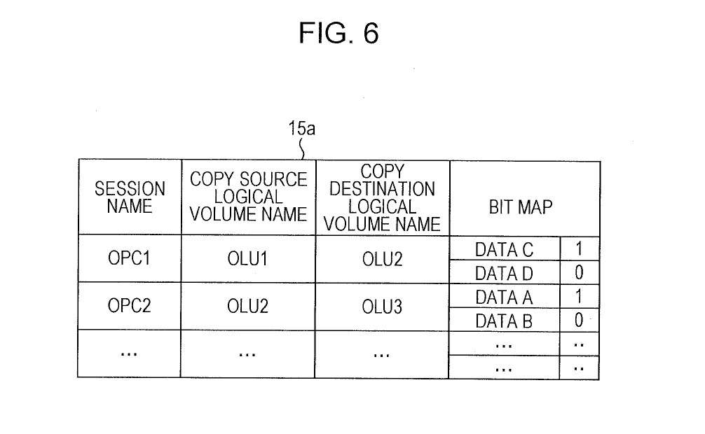

FIG. 6 is a diagram illustrating the OPC management information.

The OPC management information is stored in an OPC management table 15a of the OPC management information storage unit 15.

A session name field, a copy source logical volume name field, a copy destination logical volume name field and a bit map field are included in the OPC management table 15a. Information pieces that are arranged in a lateral direction are associated with each other in the OPC management table 15a.

A name that identifies an OPC session is set in the session name field.

An OLU number of a logical volume that is a data copy source and for which the OPC session is established is set in the copy source logical volume name field.

An OLU number of a logical volume that is a data copy destination and for which the OPC session is established is set in the copy destination logical volume name field.

Information that identifies the progress of OPC is set in the bit map field for each of storage regions. When the OPC processor 14 receives, from the host device 30, a permission (specifying a copy source logical volume) to activate OPC, the OPC processor 14 sets, to “1”, all bits of bit maps that correspond to the copy source logical volume specified in the received permission and are indicated in the OPC management table 15a. Then, the OPC processor 14 starts OPC.

Next, a process that is performed by the write request processor 13 is described using a flowchart.

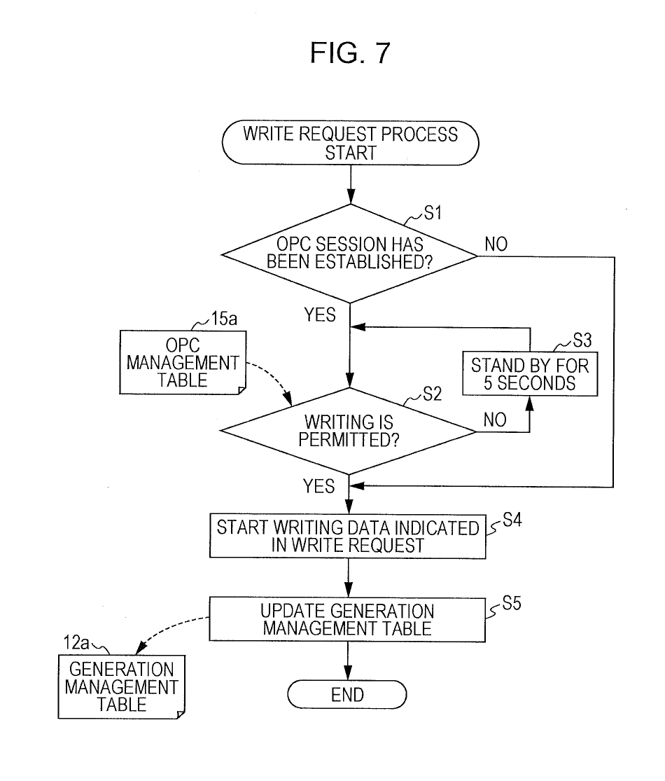

FIG. 7 is a flowchart of the process to be performed by the write request processor 13.

In step S1, the write request processor 13 references the copy source logical volume name field of the OPC management table 15a and determines whether or not an OPC session has been established between a logical volume (hereinafter referred to as “interested logical volume” in the following description using FIG. 7) that is specified by the host device 30 and in which data is to be written and another logical volume. When the OPC session has been established between the interested logical volume and the other logical volume (Yes in step S1), the process proceeds to step S2. When the OPC session is not established between the interested logical volume and the other logical volume (No in step S1), the process proceeds to step S4.

In step S2, the write request processor 13 references the bit map field of the OPC management 15a and determines whether or not a bit that is included in a bit map and corresponds to a region (in which the data is to be written) indicated in a write request is “0”. When the bit that is included in the bit map and corresponds to the region indicated in the write request is “0” (Yes in step S2), the process proceeds to step S4. When the bit that is included in the bit map and corresponds to the region indicated in the write request is not “0” (No in step S2), the process proceeds to step S3.

In step S3, the write request processor 13 causes the write request to be stored in a queue and stands by 5 seconds. The time of 5 seconds is an example. After the time of 5 seconds elapses, the process returns to step S2.

In step S4, the write request processor 13 starts writing the data indicated in the write request in the region indicated in the write request. When the writing is completed, the process proceeds to step S5.

In step S5, the write request processor 13 creates a generation management table 12a that is related to the data written in step S4. In addition, the write request processor 13 updates details of another generation management table 12a that is related to the writing. After that, the process illustrated in FIG. 7 is terminated.

Next, an OPC activation process that is performed by the OPC processor 14 is described.

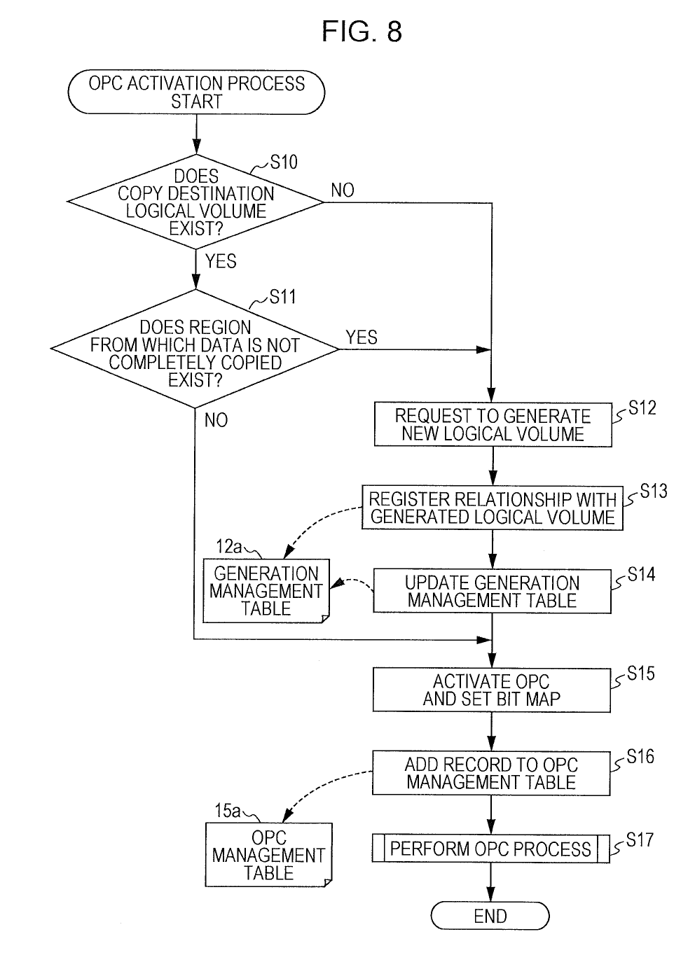

FIG. 8 is a flowchart of the OPC activation process.

In step S10, the OPC processor 14 determines whether or not a logical volume (copy destination logical volume) into which data is to be copied exists. Specifically, when the OPC processor 14 references a previous width generation number field of an interested generation management table 12a. When a previous width generation number exists in the referenced previous width generation number field, the OPC processor 14 determines that the copy destination logical volume exists. When the copy destination logical volume exists (Yes in step S10), the process proceeds to S11. When the copy destination logical volume does not exist (No in step S10), the process proceeds to S12.

In step S11, the OPC processor 14 references a bit map for a copy source logical volume and determines whether or not a region (indicated by “1” of a bit of the bit map) from which data is not completely copied exists in the copy source logical volume. When the region from which the data is not completely copied exists in the copy source logical volume (Yes in step S11), the process proceeds to step S12 in order to perform an interrupt process. When the region from which the data is not completely copied does not exist in the copy source logical volume (No in step S11), the process proceeds to step S15.

In step S12, the OPC processor 14 requests the logical volume generator 11 to assign a new logical volume from the storage pool 20b. After that, the process proceeds to step S13.

In step S13, the OPC processor 14 creates a generation management table 12a that has, set therein, an interrupt generation number, a relationship with the copy source logical volume, and a logical volume number of the new logical volume generated by the logical volume generator 11 on the basis of the request in step S12. After that, the process proceeds to step S14.

In step S14, the OPC processor 14 reflects details of the generation management table 12a generated in step S13 in the existing generation management table 12a. Specifically, the OPC processor 14 references the previous width generation number field of the generation management table 12a corresponding to data stored in the copy source logical volume. Then, the OPC processor 14 sets the generation number of the created generation management table 12a in the field for the next width generation number of the existing generation management table 12a in which a number that matches a previous width generation number set in the referenced field for the previous width generation number is set in the field for the generation number. After that, the process proceeds to step S15.

In step S15, the OPC processor 14 establishes an OPC session in which a logical volume specified by the host device 30 is treated as a copy source logical volume, and the OPC processor 14 starts OPC and sets, to “1”, a bit that is included in a bit map and corresponds to the region from which data is to be copied. After that, the process proceeds to step S16.

In step S16, the OPC processor 14 adds, to the OPC management table 15a, a record that has set therein information on OPC that has started in step S15. After that, process proceeds to step S17.

In step S17, the OPC processor 14 performs the OPC process. The OPC process is described later in detail. When the OPC process is terminated, the process illustrated in FIG. 8 is terminated.

The description of the OPC activation process ends.

Next, the OPC process of step S17 is described.

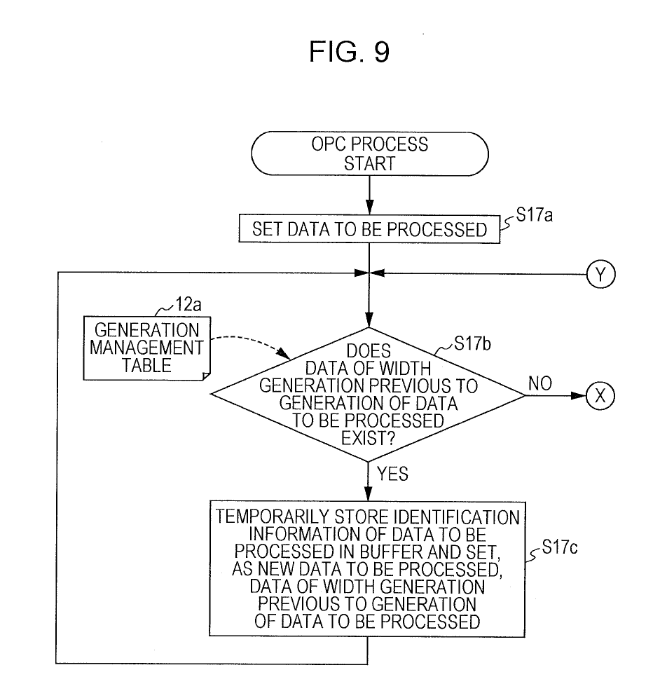

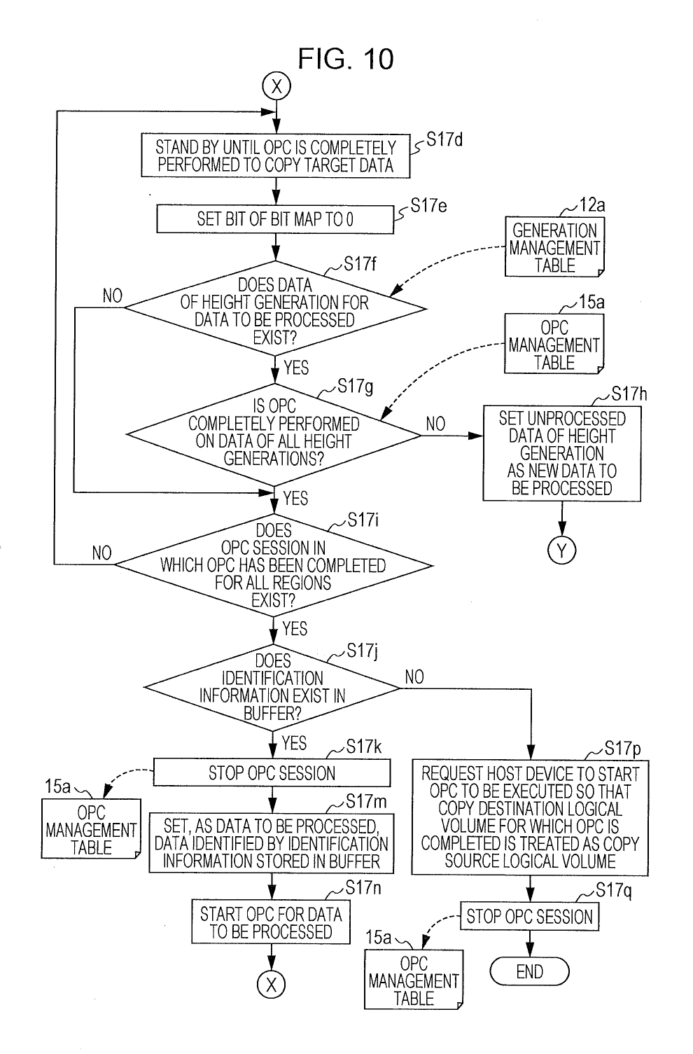

FIGS. 9 and 10 are flowcharts of the OPC process.

In step S17a, the OPC processor 14 sets, as data to be processed, the data stored in a region from which the data is to be copied and that is included in the copy source logical volume. After that, the process proceeds to step S17b.

In step S17b, the OPC processor 14 references a previous width generation field of a generation management table 12a corresponding to the data (to be processed) set in step S17a and determines whether or not data of a width generation that is previous to the generation of the data to be processed exists. When the data of the width generation that is previous to the generation of the data to be processed exists (Yes in step S17b), the process proceeds to step S17c. When the data of the width generation that is previous to the generation of the data to be processed does not exist (No in step S17b), the process proceeds to step S17d illustrated in FIG. 10.

In step S17c, the OPC processor 14 causes identification information of the data to be processed to be temporarily stored in a buffer and sets, as new data to be processed, the data of the width generation previous to the generation of the data to be processed. After that, the process proceeds to step S17b.

In step S17d, the OPC processor 14 stands by until the data to be processed is completely copied. After that, the process proceeds to step S17e.

In step S17e, the OPC processor 14 sets, to “0”, a bit that is included in a bit map and corresponds to a region from which the data has been completely copied. After that, the process proceeds to step S17f.

In step S17f, the OPC processor 14 references a height generation field of a generation management table 12a corresponding to the data to be processed, and determines whether or not data of a height generation for the data to be processed exists. When the data of the height generation for the data to be processed exists (Yes in step S17f), the process proceeds to step S17g. When the data of the height generation for the data to be processed does not exist (No in step S17f), the process proceeds to step 17i.

In step S17g, the OPC processor 14 references each of records of the OPC management table 15a and determines whether or not data of all height generations for the data to be processed is completely copied. Specifically, the OPC processor 14 determines whether or not an OPC session that is related to the data of the height generations has been set in the OPC management table 15a. When the data of all the height generations for the data to be processed is completely copied (Yes in step S17g), the process proceeds to step S17i. When any of data of all the height generations for the data to be processed is not completely copied (No in step S17g), the process proceeds to step S17h.

In step S17h, the OPC processor 14 sets unprocessed data of a height generation as data to be processed. After that, the process returns to step S17b illustrated in FIG. 9 so that steps S17b and later are performed.

In step S17i, the OPC processor 14 references bit maps and determines whether or not an OPC session in which data has been completely copied from and into all regions exists. When the OPC session in which the data has been completely copied from and into all the regions exists (Yes in step S17i), the process proceeds to step S17j. When the OPC session in which the data has been completely copied from and into all the regions does not exist (No in step S17i), the process returns to step S17d.

In step S17j, the OPC processor 14 determines whether or not the identification information of the data to be processed exists in the buffer or whether or not the identification information temporarily stored in step S17c exists. When the identification information exists in the buffer (Yes in step S17j), the process proceeds to step S17k. When the identification information does not exist in the buffer (No in step S17j), the process proceeds to step 17p.

In step S17k, the OPC processor 14 stops the OPC session in which the data has been completely copied. In addition, the OPC processor 14 deletes a record that is included in the OPC management table 15a and matches the session name of the stopped OPC session. After that, the process proceeds to step S17m.

In step S17m, the OPC processor 14 sets, as data to be processed, the data identified by the identification information stored in the buffer. After that, the process proceeds to step S17n.

In step S17n, the OPC processor 14 starts OPC for the data to be processed. After that, the process proceeds to step S17.

In step S17p, the OPC processor 14 requests the host device 30 to start OPC to be executed so that a copy destination logical volume in which copying has been completed is treated as a copy source logical volume. After that, the process proceeds to step S17q.

In step S17q, the OPC processor 14 stops the OPC session in which the data has been completely completed. In addition, the OPC processor 14 deletes a record that is included in the OPC management table 15a and matches the session name of the stopped OPC session. After that, the OPC process is terminated.

The description of the OPC process ends.

In the OPC process described with reference to in FIGS. 9 and 10, when OPC is completed for all regions, the OPC processor 14 requests the host device 30 to start OPC to be executed so that a copy destination logical volume in which the copying has been completed is treated as a copy source logical volume. It is, therefore, possible to suppress the start of OPC to be executed so that a logical volume into which a part of data to be copied has been copied is treated as a copy source logical volume. After the OPC processor 14 executes OPC and completely copy data of a previous generation, the OPC processor 14 starts OPC to copy data of a next generation. Thus, the time to start copying data by execution of OPC using an OPC session and the time to start copying data by execution of OPC using another OPC session can be linked with each other.

A process that is performed by the write request processor 13 and the OPC processor 14 is described using specific examples.

### First Specific Example

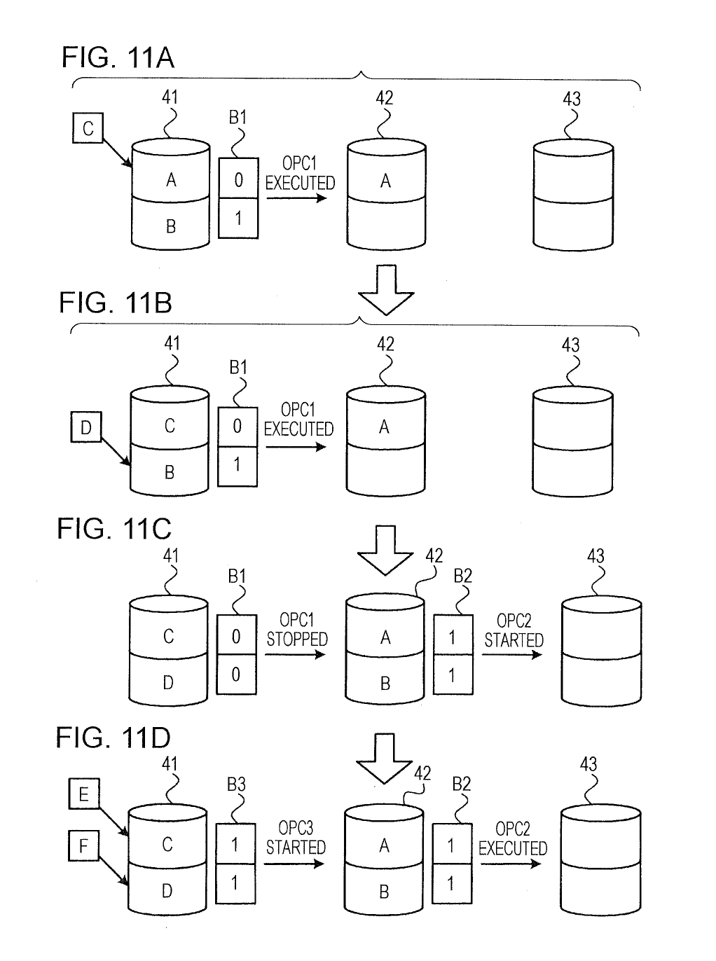

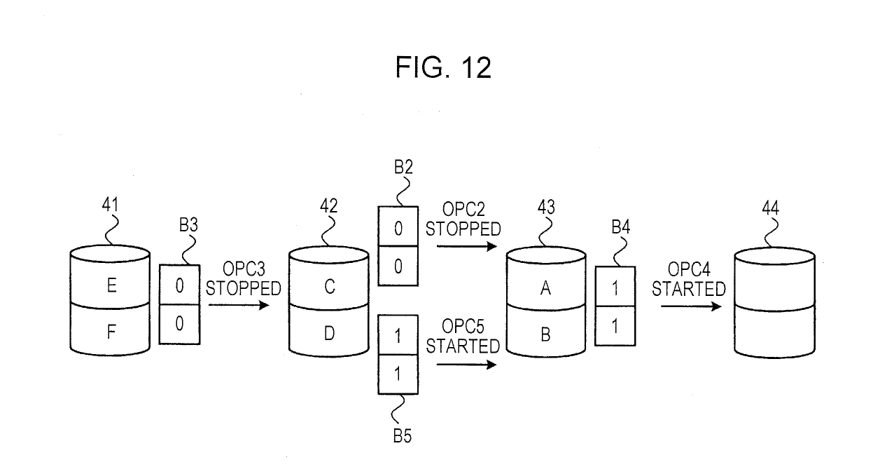

FIGS. 11A to 12 are diagrams illustrating a first specific example.

A transition state of a process to be performed by the write request processor 13 changes from a state illustrated in FIG. 11A to a state illustrated in FIG. 11D.

FIG. 11A illustrates a state in which an OPC session (hereinafter referred to as OPC session OPC1) whose session name is OPC1 is established between the logical volume 41 and the logical volume 42 in accordance with a request (issued by the host device 30) to activate OPC, and the write request processor 13 copies all the data A and B stored in the logical volume 41 into the logical volume 42. A bit map B1 illustrated in FIG. 11A corresponds to a bit map set in a field that is included in the OPC management table 15a and corresponds to OPC1 indicated in the session name field of the OPC management table 15a. In FIG. 11A, a state in which OPC is being executed using the OPC session OPC1 is indicated by “OPC executed”. In this state, when the write request processor 13 receives, from the host device 30, a request to rewrite the data C in a region in which the data A is stored in the logical volume 41, the write request processor 13 references the copy source logical volume name field of the OPC management table 15a and determines whether or not an OPC session that includes the logical volume 41 has been established (in step S1). In the first specific example, the OPC session OPC1 that includes the logical volume 41 has been established as illustrated in FIG. 11A. Thus, the write request processor 13 references, at each of time intervals of 5 seconds, a field included in the OPC management table 15a and indicating the bit map corresponding OPC1 indicated in the session name field, and stands by until the bit that is included in the bit map B1 and corresponds to the data A is set to “0” (in steps S2 and S3).

When the data A is completely copied using the OPC session OPC1 (in step S17d), the OPC processor 14 sets, from “1” to “0”, the bit that is included in the bit map B1 and corresponds to the region in which the data A is stored in the logical volume 41 (in step S17e). When the bit of the bit map B1 is set from “1” to “0”, the write request processor 13 can rewrite the data C in the region in which the data A is stored in the logical volume 41 (Yes in step S2 and steps S4 and later).

After that, when the write request processor 13 receives, from the host device 30, a request to rewrite the data D in the region in which the data B is stored in the logical volume 41 as illustrated in FIG. 11B, the write request processor 13 references the copy source logical volume name field of the OPC management table 15a and determines whether or not an OPC session that includes the logical volume 41 has been established (in step S1). In the first specific example, the OPC session OPC1 that includes the logical volume 41 has been established as illustrated in FIG. 11B. Thus, the write request processor 13 references a field included in the OPC management table 15a and indicating the bit map B1 corresponding OPC1 indicated in the OPC session name field and stands by until the bit that is included in the bit map B1 and corresponds to the data B is set to “0” (in steps S2 and S3).

After that, when the data B is completely copied (in step S17d), the OPC processor 14 sets from “1” to “0”, the bit that is included in the bit map B1 and corresponds to the region in which the data B is stored in the logical volume 41, as illustrated in FIG. 11C (in step S17e). When the bit of the bit map B1 is set from “1” to “0”, the write request processor 13 can rewrite the data D in the region in which the data B is stored in the logical volume 41 (Yes in step S2 and in steps S4 and later).

When the OPC processor 14 confirms that all the bits of the bit map B1 are “0” (Yes in step S171), the OPC processor 14 references the OPC management table 15a and requests the host device 30 to establish an OPC session in which a logical volume that has a logical volume name “OLU2” that is set in the copy destination logical volume name field and corresponds to OPC1 set in the session name field is treated as a copy source logical volume (in step S17p). After that, the OPC processor 14 deletes a record for the session name OPC1 from the OPC management table 15a (in step S17q).

After that, when the OPC processor 14 receives, from the host device 30, a request (issued by the host device 30 in response to the request to establish the OPC session) to copy data from the logical volume 42 into the logical volume 43, the OPC processor 14 performs the OPC activation process. Specifically, the OPC processor 14 establishes an OPC session OPC2 (whose OPC session name is OPC2) between the logical volumes 42 and 43 and prepares a bit map B2 (in step S15). In addition, the OPC processor 14 adds a record relating to the established OPC session OPC2 to the OPC management table 15a (in step S16). Then, the OPC processor 14 starts the OPC process using the OPC session OPC2 (in step S17).

After that, when the OPC processor 14 receives, from the host device 30, a request to copy data from the logical volume 41 into the logical volume 42, the OPC processor 14 performs the OPC activation process. Specifically, the OPC processor 14 establishes an OPC session OPC3 (whose session name is OPC3) between the logical volumes 41 and 42 and prepares a bit map B3 (in step S15). In addition, the OPC processor 14 adds a record relating to the established OPC session OPC3 to the OPC management table 15a (in step S16). Then, the OPC processor 14 starts the OPC process using the OPC session OPC3 (in step S17).

After that, when the write request processor 13 receives, from the host device 30, a request to rewrite the data E in the region in which the data C is stored in the logical volume 41 and a request to rewrite the data F in the region in which the data D is stored in the logical volume 41, the write request processor 13 references the copy source logical volume name field and copy destination logical volume name field of the OPC management table 15a and determines whether or not an OPC session that includes the logical volume 41 has been established (in step S1). In the first specific example, the OPC session OPC3 that includes the logical volume 41 has been established as illustrated in FIG. 11D. Thus, the write request processor 13 references a field included in the OPC management table 15a and indicating the bit map B3 corresponding to OPC3 indicated in the session name field of the OPC management table 15a and stands by until bits that are included in the bit map B3 and corresponds to the data C and D are set to “0” (in steps S2 and S3).

The OPC processor 14 sets the data C and D as data to be processed in order to execute OPC using the OPC session OPC3 (in step S17). The OPC processor 14 determines whether or not data of a width generation that is previous to the generation of the data to be processed exists (in step S17). As the results of the determination, the data A and B exists. Thus, the OPC processor 14 sets the data A and B as data to be processed (in step S17c). Since data of a width generation that is previous to the generation of the data A and B does not exist, the OPC processor 14 stands by until the data A and B is completely copied using the OPC session OPC2 (in step S17d). When the data A and B is completely copied using the OPC session OPC2, the OPC processor 14 updates, from “1” to “0”, the bits of the bit map B2 that corresponds to the regions in which the data A and B is stored in the logical volume 42 (in step S17e). When the OPC processor 14 updates, from “1” to “0”, the bits of the bit map B2 that corresponds to the regions in which the data A and B is stored in the logical volume 42, the OPC processor 14 can rewrite the data C in the region in which the data A is stored in the logical volume 42. In addition, the OPC processor 14 can rewrite the data D in the region in which the data B is stored in the logical volume 42 (Yes in step S2 and in steps S4 and later).

Since the copying is completed using the OPC session OPC2 for all the regions, the OPC processor 14 requests the host device 30 to start OPC to be executed so that the logical volume 43 that is a copy destination of the OPC session OPC2 is treated as a copy source of an OPC session (in step S17p). After that, the OPC processor 14 stands by for 5 seconds and then deletes a record for the session name OPC2 from the OPC management table 15a.

After that, the OPC processor 14 sets the data C and D as data to be processed (in step S17m). Then, the OPC processor 14 stands by until the data C and D is completely copied using the OPC session OPC3 (in step S17d).

When the data C and D is completely copied using the OPC session OPC3, the OPC processor 14 updates, from “1” to “0”, the bits that are included in the bit map B3 and correspond to the regions in which the data C and D are stored in the logical volume 41 (in step S17e). By updating the bits of the bit map B3 (corresponding to the regions in which the data C and D are stored in the logical volume 41) from “1” to “0”, the OPC processor 14 can rewrite the data E in the region in which the data C is stored in the logical volume 41. In addition, the OPC processor 14 can rewrite the data F in the region in which the data D is stored in the logical volume 41.

Since the copying is completed using the OPC session OPC3 for all the regions, the OPC processor 14 requests the host device 30 to start OPC to be executed so that the logical volume 42 that is the copy destination of the OPC session OPC3 is treated as a copy source of an OPC session (in step S17p). After that, the OPC processor 14 stands by for 5 seconds and then deletes a record for the session name OPC3 from the OPC management table 15a (in step S17q).

When the OPC processor 14 receives a request (issued by the host device 30 in response to the request (issued by the OPC processor 14) to establish the OPC session in which the logical volume 43 is treated as the copy source of the OPC session) to copy data from the logical volume 43, the OPC processor 14 performs the OPC activation process. Specifically, since a copy destination logical volume does not exist (No in step S10), the OPC processor 14 requests the logical volume generator 11 to assign a new logical volume from the storage pool 20b (in step S12). The logical volume generator 11 generates a logical volume 44 in response to the request provided by the OPC processor 14 as illustrated in FIG. 12. The OPC processor 14 registers a relationship between the generated logical volume 44 and the logical volume 43 in a generation management table 12a (in step S13). In addition, the OPC processor 14 updates the generation management table 12a for the copy destination (in step S14). Then, the OPC processor 14 establishes an OPC session OPC4 (whose session name is OPC4) between the logical volumes 43 and 44 and prepares a bit map B4 (in step S15). Next, the OPC processor 14 adds a record relating to the established OPC session OPC4 to the OPC management table 15a (in step S16). Then, the OPC processor 14 starts the OPC process using the OPC session OPC4 (in step S17).

When the OPC processor 14 receives a request (issued by the host device 30 in response to the request (issued by the OPC processor 14) to establish an OPC session in which the logical volume 42 is treated as the copy source of the OPC session) to copy data from the logical volume 42, the OPC processor 14 performs the OPC activation process. Specifically, the OPC processor 14 establishes an OPC session OPC5 (whose session name is OPC5) between the logical volumes 42 and 43 and prepares a bit map B5 (in step S15). Then, the OPC processor 14 adds a record relating to the established OPC session OPC5 to the OPC management table 15a (in step S16). The OPC processor 14 starts the OPC process using the OPC session OPC5 (in step S17).

### Second Specific Example

Next, a second specific example of the OPC process to be performed by the control module 10a is described.

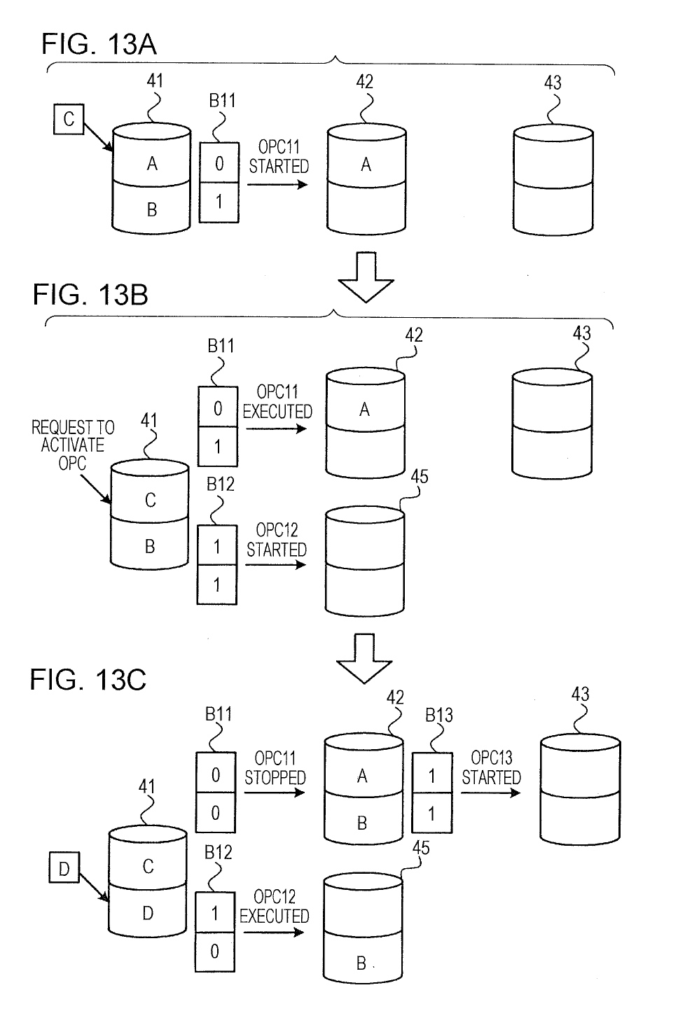

FIGS. 13A to 13C are diagrams illustrating the second specific example.

A transition state of a process to be performed by the write request processor 13 changes from a state illustrated in FIG. 13A to a state illustrated in FIG. 13C.

FIG. 13A illustrates a state in which the OPC processor 14 performs the OPC activation process in accordance with a request (issued by the host device 30) to copy data, establishes an OPC session OPC11 (whose session name is OPC11) between the logical volumes 41 and 42, and copies all the data A and B stored in the logical volume 41 into the logical volume 42. In this state, when the write request processor 13 receives, from the host device 30, a request to rewrite the data C in the region in which the data A is stored in the logical volume 41, the write request processor 13 references the copy source logical volume name field of the OPC management table 15a and determines whether or not an OPC session that includes the logical volume 41 has been established. In the second specific example, the OPC session OPC11 that includes the logical volume 41 has been established as illustrated in FIG. 13A. Thus, the write request processor 13 references, at each of time intervals of 5 seconds, a field included in the OPC management table 15a and indicating a bit map B11 corresponding to OPC11 indicated in the session name field of the OPC management table 15a, and stands by until a bit that is included in the bit map and corresponds to the data A is set to “0” (in steps S2 and S3).

When the data A is completely copied using the OPC session OPC11 (in step S17d), the OPC processor 14 updates, from “1” to “0”, a bit that is included in the bit map B11 and corresponds to the region in which the data A is stored in the logical volume 41 (in step S17e). When the bit of the bit map B11 is set from “1” to “0”, the write request processor 13 can rewrite the data C in the region in which the data A is stored in the logical volume 41 (Yes in step S2 and in steps S4 and later).

After that, when the write request processor 13 receives, from the host device 30, an instruction to back up the data stored in the logical volume 41 during the establishment of the OPC session OPC11 as illustrated in FIG. 13B, the write request processor 13 references the copy source logical volume name field and copy destination logical volume name field of the OPC management table 15a and determines whether or not an OPC session that includes the logical volume 41 has been established (in step S1). In the second specific example, the OPC session OPC11 that includes the logical volume 41 has been established as illustrated in FIG. 13B. Thus, the OPC processor 14 references the bit map B11 for the OPC session OPC11 and determines whether or not a region for which copying is not completed exists (in step S11). In the second specific example, the region for which the copying is not completed exists as illustrated in FIG. 13B. Thus, the OPC processor 14 requests the logical volume generator 11 to assign a new logical volume from the storage pool 20b (in step S12).

The logical volume generator 11 generates a logical volume 45 in response to the request provided by the OPC processor 14. The OPC processor 14 registers a relationship between the generated logical volume 45 and the logical volume 41 in a generation management table 12a (in step S13). Specifically, the OPC processor 14 causes information identifying an interrupt generation for the generation of the data A and B to be stored in the interrupt generation number field of the generation management table 12a. In addition, the OPC processor 14 updates the generation management table 12a for the copy destination (in step S14). Then, the OPC processor 14 establishes an OPC session OPC12 (whose session name is OPC12) between the logical volumes 41 and 45 and prepares a bit map B12 (in step S15). Next, the OPC processor 14 adds a record relating to the established OPC session OPC12 to the OPC management table 15a (in step S16). Then, the OPC processor 14 starts the OPC process using the OPC session OPC12 (in step S17).

After that, when the write request processor 13 receives, from the host device 30, a request to rewrite the data D in the region in which the data B is stored in the logical volume 41 before termination of the copying using the OPC session OPC11 as illustrated in FIG. 13C, the write request processor 13 references the copy source logical volume name field of the OPC management table 15a and determines whether or not an OPC session that includes the logical volume 41 has been established (in step S1). In the second specific example, the OPC sessions OPC11 and OPC12 that each include the logical volume 41 have been established as illustrated in FIG. 13B. Thus, the write request processor 13 references, at each of time intervals of 5 seconds, a field included in the OPC management table 15a and indicating the bit map B11 corresponding to OPC11 indicated in the session name field of the OPC management table 15a, and stands by until the bits that are included in the bit maps B11 and B12 and correspond to the data B are set to “0” (in steps S2 and S3).

When the data B is completely copied using the OPC session OPC11 (in step S17d), the OPC processor 14 updates, from “1” to “0”, the bit that is included in the bit map B11 and corresponds to the region in which the data B is stored in the logical volume 41 (in step S17e). When the data B is completely copied using the OPC session OPC12 (in step S17d), the OPC processor 14 updates, from “1” to “0”, the bit that is included in the bit map B12 and corresponds to the region in which the data B is stored in the logical volume 41 (in step S17e). When the bits that are included in the bit maps B11 and B12 and correspond to the region in which the data B is stored are set from “1” to “0”, the write request processor 14 can rewrite the data D in the region in which the data B is stored in the logical volume 41 (Yes in step S2 and in steps S4 and later).

When the OPC processor 14 confirms that all the bits of the bit map B11 are “0” (in step S17f), the OPC processor 14 determines whether or not an OPC session in which copying has been completed for all regions exists (in step S170. In the second specific example, since the OPC session OPC11 in which the copying has been completed for all the regions exists, the OPC processor 14 requests the host device 30 to start OPC to be executed so that the logical volume 42 that is the copy source of the OPC session 11 is treated as a copy source of an OPC session (in step S17p).

After that, the OPC processor 14 deletes a record relating to the session name OPC 11 from the OPC management table 15a (in step S17q).

When the OPC processor 14 receives a request (issued by the host device 30 in response to the request (issued by the OPC processor 14) to establish the OPC session in which the logical volume 42 is the copy source of the OPC session) to copy data from the logical volume 42, the OPC processor 14 performs the OPC activation process. Specifically, the OPC processor 14 establishes an OPC session OPC13 (whose session name is OPC13) between the logical volumes 42 and 43 and prepares a bit map B13 (in step S15). Next, the OPC processor 14 adds a record relating to the established OPC session OPC13 to the OPC management table 15a (in step S16). Then, the OPC processor 14 starts the OPC process using the OPC session OPC13 (in step S17).

In the second specific example, the latest data that is stored in the logical volume 41 can be backed up even during the writing using the OPC session OPC11.

### Third Specific Example

Next, a third specific example of the OPC process to be performed by the control module 10a is described.

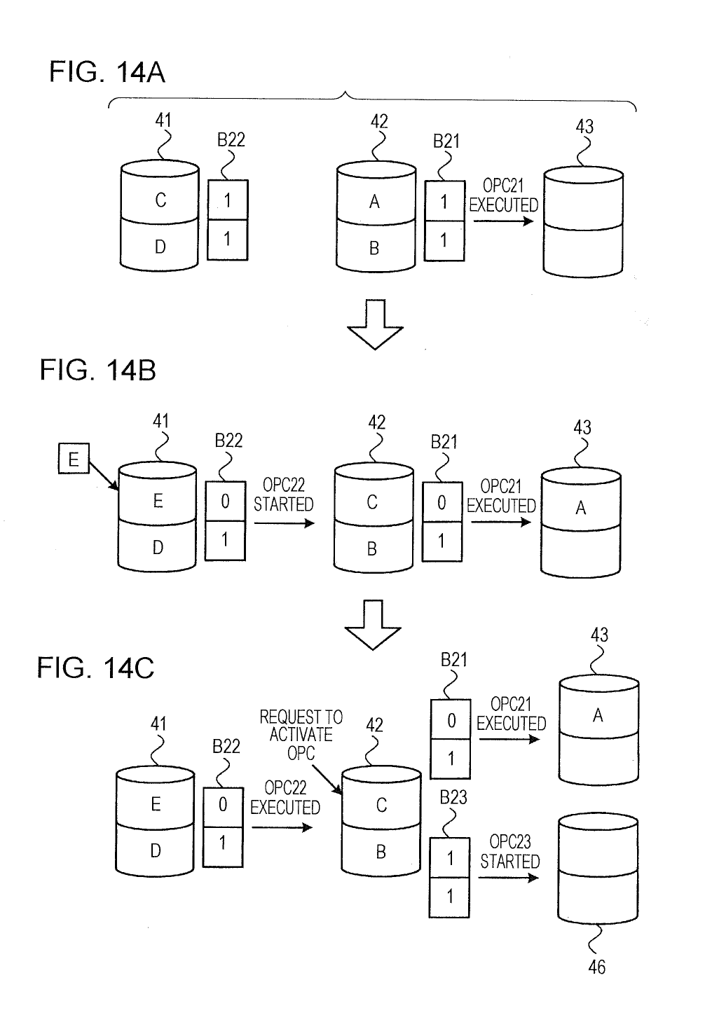

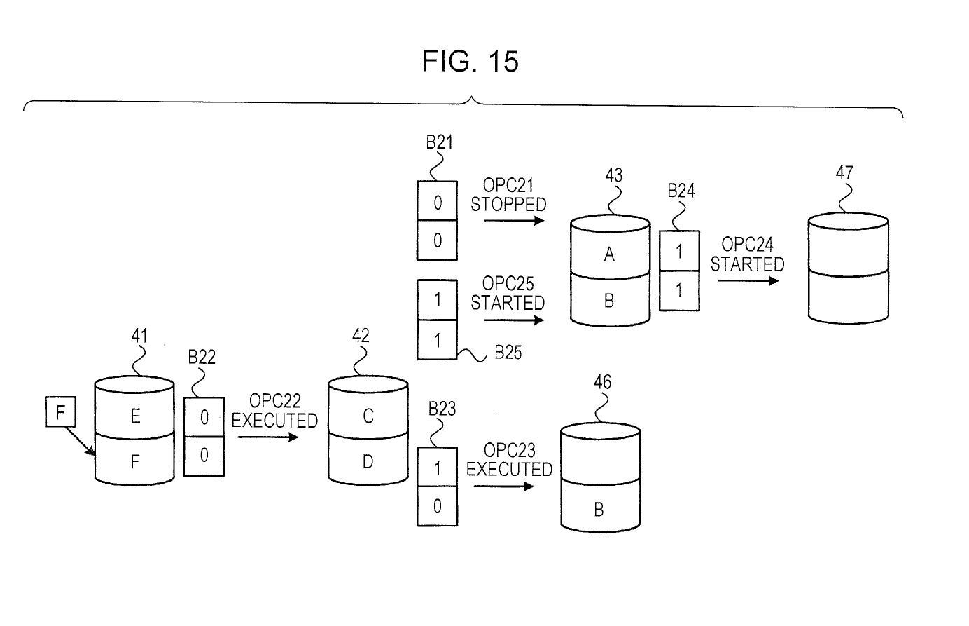

FIGS. 14A to 15 are diagrams illustrating the third specific example.

A transition state of a process to be performed by the write request processor 13 changes from a state illustrated in FIG. 14A to a state illustrated in FIG. 14C.

FIG. 14A illustrates a state in which the OPC processor 14 establishes an OPC session OPC21 (whose session name is OPC21) between the logical volumes 42 and 43 in accordance with a request (issued by the host device 30) to activate OPC and the write request processor 13 performs a process of copying all the data A and B stored in the logical volume 42 into the logical volume 43. In this state, when the OPC processor 14 receives, from the host device 30, a request to copy data from the logical volume 41 into the logical volume 42, the OPC processor 14 performs the OPC activation process and adds a record to the OPC management table 15a (in step S16). Then, the OPC processor 14 establishes an OPC session OPC22 (whose session name is OPC22) between the logical volumes 41 and 42. The OPC processor 14 prepares a bit map B22 and starts the OPC process using the OPC session OPC22 (in step S17).

After that, when the write request processor 13 receives, from the host device 30, a request to rewrite the data E in the region in which the data C is stored in the logical volume 41 as illustrated in FIG. 14B, the rewrite request processor 13 references the copy source logical volume name field of the OPC management table 15a and determines whether or not an OPC session that includes the logical volume 41 has been established (in step S1). In the third specific example, the OPC session OPC22 that includes the logical volume 41 has been established as illustrated in FIG. 14B. Thus, the write request processor 13 references a field included in the OPC management table 15a and indicating the bit map B22 corresponding to OPC22 indicated in the session name field of the OPC management table 15a and stands by until a bit that is included in the bit map B22 and corresponds to the data C is set to “0” (in steps S2 and S3). When the data C is completely copied using the OPC session OPC22, the OPC processor 14 updates, from “1” to “0”, the bit that is included in the bit map B22 and corresponds to the region in which the data C is stored in the logical volume 42 (in step S17e). When the OPC processor 14 updates, from “1” to “0”, the bit that is included in the bit map B22 and corresponds to the region in which the data C is stored in the logical volume 42, the write request processor 13 can rewrite the data E in the region in which the data C is stored in the logical volume 41 (Yes in step S2 and in steps S4 and later).

After that, when the OPC processor 14 receives, from the host device 30, a request to activate OPC for the logical volume 42 during the establishment of the OPC session OPC22 as illustrated in FIG. 14C, the OPC processor 14 references the bit map B21 for the OPC session OPC21 and determines whether or not a region for which copying is not completed exists (in step S11). In the third specific example, the region for which the copying is not completed exists as illustrated in FIG. 14C. Thus, the OPC processor 14 requests the logical volume generator 11 to assign a new logical volume from the storage pool 20b (in step S12).

The logical volume generator 11 generates a logical volume 46 in accordance with the request provided by the OPC processor 14. The OPC processor 14 registers a relationship between the generated logical volume 46 and the logical volume 42 in a generation management table 12a (in step S13). Specifically, the OPC processor 14 causes information identifying an interrupt generation for the generation of the data A and B to be stored in the interrupt generation number field of the generation management table 12a. In addition, the OPC processor 14 updates the generation management table 12a for the copy destination (in step S14). Then, the OPC processor 14 establishes an OPC session OPC23 (whose session name is OPC23) between the logical volumes 42 and 46 and prepares a bit map B23 (in step S15). Next, the OPC processor 14 adds a record relating to the established OPC session OPC23 to the OPC management table 15a (in step S16). Then, the OPC processor 14 starts the OPC process using the OPC session OPC23 (in step S17).

After that, when the write request processor 13 receives, from the host device 30, a request to rewrite the data F in the region in which the data D is stored in the logical volume 41, the write request processor 13 references the copy source logical volume name field of the OPC management table 15a and determines whether or not an OPC session that includes the logical volume 41 has been established (in step S1). In the third specific example, the OPC session OPC22 that includes the logical volume 41 has been established as illustrated in FIG. 14C. Thus, the write request processor 13 references, at each of time intervals of 5 seconds, a field included in the OPC management table 15a and indicating the bit map B22 corresponding to OPC22 indicated in the session name field of the OPC management table 15a and stands by until the bit that is included in the bit map B22 and corresponds to the data D is set to “0” (in steps S2 and S3).

When the data B is completely copied using the OPC session OPC21 (in step S17d), the OPC processor 14 updates, from “1” to “0”, a bit that is included in the bit map B21 and corresponds to the region in which the data B is stored in the logical volume 42 (in step S17e). When the data B is completely copied using the OPC session OPC23 (in step S17d), the OPC processor 14 updates, from “1” to “0”, a bit that is included in the bit map B23 and corresponds to the region in which the data B is stored in the logical volume 42 (in step S17e). When the bits that are included in the bit maps B21 and B23 and correspond to the region in which the data B is stored are set from “1” to “0”, the write request processor 13 can rewrite the data D in the region in which the data B is stored in the logical volume 42.

Since the copying is completed for all the regions using the OPC session OPC21, the OPC processor 14 requests the host device 30 to start OPC to be executed so that the logical volume 43 that is the copy destination of the OPC session OPC21 is treated as a copy source of an OPC session (in step S17p). After that, the OPC processor 14 stands by for 5 or more seconds and then deletes a record for the session name OPC21 from the OPC management table 15a (in step S17q).

After that, when the OPC processor 14 receives a request (issued by the host device 30 in response to the request (issued by the OPC processor 14) to establish the OPC session in which the logical volume 43 is treated as the copy source of the OPC session) to copy data from the logical volume 43, the OPC processor 14 performs the OPC activation process. Specifically, since a copy destination logical volume does not exist (No in step S10), the OPC processor 14 requests the logical volume generator 11 to assign a new logical volume from the storage pool 20b (in step S12). The logical volume generator 11 generates a logical volume 47 in accordance with the request provided by the OPC processor 14 as illustrated in FIG. 15. The OPC processor 14 registers a relationship between the generated logical volume 47 and the logical volume 43 in a generation management table 12a (in step S13). In addition, the OPC processor 14 updates the generation management table 12a for the copy destination (in step S14). Then, the OPC processor 14 establishes an OPC session OPC24 (whose session name is OPC24) between the logical volumes 43 and 47 and prepares a bit map B24 (in step S15). Next, the OPC processor 14 adds a record relating to the established OPC session OPC24 to the OPC management table 15a (in step S16). Then, the OPC processor 14 starts the OPC process using the OPC session OPC24 (in step S17).

When the data D is completely copied using the OPC session OPC 22, the OPC processor 14 updates, from “1” to “0”, the bit that is included in the bit map B22 and corresponds to the region in which the data D is stored in the logical volume 41 (in step S17e). When the OPC processor 14 updates the bit of the bit map B22 from “1” to “0”, the write request processor 13 can rewrite the data F in the region in which the data D is stored in the logical volume 41.

After that, when the OPC processor 14 receives, from the host device 30, a request (issued by the host device 30 in response to the request to establish an OPC session in which the logical volume 42 is treated as a copy source of the OPC session) to copy data from the logical volume 43, the OPC processor 14 performs the OPC activation process. Specifically, the OPC processor 14 establishes an OPC session OPC25 (whose session name is OPC25) between the logical volumes 42 and 43 and prepares a bit map B25 (in step S25). Next, the OPC processor 14 adds a record relating to the established OPC session OPC25 to the OPC management table 15a (in step S16). Then, the OPC processor 14 starts the OPC process using the OPC session OPC25 (in step S17). The description of the third specific example ends.

The present embodiment describes OPC (copying in a chassis) to be executed in the storage apparatus 100. The present embodiment, however, can be applied to copying that is performed between chasses.

The control device disclosed herein, the control method disclosed herein and the storage apparatus disclosed herein are described above with reference to the accompanying drawings. The control device disclosed herein, the control method disclosed herein and the storage apparatus disclosed herein, however, are not limited to the aforementioned embodiments. The configurations of the aforementioned parts may be replaced with arbitrary configurations of parts that have the same functions as the aforementioned parts. In addition, an arbitrary constituent part may be added to the control device disclosed herein and the storage apparatus disclosed herein. An arbitrary process may be added to the control method disclosed herein.

The control device disclosed herein and the storage apparatus disclosed herein may be each configured by combining two or more of the configurations (features) described in the aforementioned embodiments. The control method disclosed herein may be performed by combining two or more features described in the aforementioned embodiments.

The aforementioned processing functions can be achieved by a computer. In this case, a program in which details of the processes to be performed by the functions of the control device 3 and the functions of the control modules 10a and 10b are described is provided. The processing functions are achieved on the computer by executing the program by means of the computer. The program in which the details of the processes are described can be stored in a computer-readable storage medium. Examples of the computer-readable storage medium are a magnetic storage apparatus, an optical disc, a magneto-optical storage medium and a semiconductor memory. Examples of the magnetic storage apparatus are a hard disk drive, a flexible disk (FD) and a magnetic table. Examples of the optical disc are a DVD, a DVD-RAM and a CD-ROM/RW. An example of the magneto-optical storage medium is a magneto-optical (MO) disk.

In order to distribute the program, a portable storage medium (such as a DVD, a CD-ROM or the like) that has the program stored therein is sold, for example. The program may be stored in a storage apparatus of a server computer and transmitted from the server computer to another computer through a network.

The computer that executes the program stores the program (stored in the portable storage medium or transmitted from the server computer) in a storage apparatus of the computer, for example. The computer reads the program from the storage apparatus of the computer and performs a process in accordance with the program. The computer may read the program directly from the portable storage medium and perform a process in accordance with the program. In addition, every time the computer receives the program from the server computer (connected to the computer through the network), the computer may perform a process in accordance with the received program.

At least a part of the aforementioned processing functions may be achieved by an electronic circuit such as a digital signal processor (DSP), an application specific integrated circuit (ASIC) or a programmable logic device (PLD).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device comprising:
a receiver that receives an instruction to update first data stored in a first volume to second data; and
a copy processor that starts copying the first data into a second volume in response to the reception of the update instruction by the receiver and limits the start of copying of the first data from the second volume into a third volume until data that is stored in the first volume is completely copied into the second volume.

2. The control device according to claim 1,
wherein when the first data that is stored in the first volume is completely copied into the second volume, the copy processor permits the first data to be copied from the first volume into the second volume.

3. The control device according to claim 1,
wherein when the data that is stored in the first volume is completely copied into the second volume, the copy processor permits the data to be copied from the second volume into the third volume.

4. The control device according to claim 1,
wherein when the receiver receives the instruction to update the first data stored in the first volume to the second data, the copy processor determines whether or not third data of a generation that is previous to a generation of the first data exists in the second volume, and
wherein when the copy processor determines that the third data exists in the second volume, the copy processor limits the start of copying of the first data from the first volume into the second volume until the third data that is stored in the second volume is completely copied into the third volume.

5. The control device according to claim 1,
wherein when the copy processor receives an instruction to copy data stored in the first volume before data that is stored in the first volume at the time of the reception of the update instruction by the receiver is completely copied into the second volume, the copy processor prepares a fourth volume and starts copying, into the fourth volume, data that is stored in the first volume at the time of the reception of the copy instruction.

6. A control method comprising:
receiving an instruction to update first data stored in a first volume to second data; and
starting copying the first data into a second volume in response to the reception of the update instruction and limiting the start of copying of the first data from the second volume into a third volume until data that is stored in the first volume is completely copied into the second volume.

7. A storage apparatus comprising:
a storage apparatus that includes a plurality of volumes in which data is stored; and
a control device that is connected to the plurality of volumes through a communication line and controls writing of information in the plurality of volumes,
wherein the control device includes
a receiver that receives an instruction to update first data stored in a first volume to second data, and
a copy processor that starts copying the first data into a second volume in response to the reception of the update instruction by the receiver and limits the start of copying of the first data from the second volume into a third volume until data that is stored in the first volume is completely copied into the second volume.
